(19) United States
(12) Patent Application Publication
(10) Pub. No.: US 2012/0192482 A1
(43) Pub. Date: Aug. 2, 2012

(54) TECHNIQUES FOR PROCESSING WASTE MATERIALS INTO USEFUL PRODUCTS

(76) Inventor: Thomas E. ASHER, Island Park, NY (US)

(21) Appl. No.: 13/361,531

(22) Filed: Jan. 30, 2012

Related U.S. Application Data
(60) Provisional application No. 61/437,837, filed on Jan. 31, 2011.

(51) Int. Cl. C10L 1/00; C02F 1/00; C02F 101/32

(52) U.S. Cl. 44/307; 210/767; 210/806; 210/252; 210/257.1

(57) ABSTRACT

Waste material, such as municipal solid waste or source separated organic waste, is subjected to a first separation treatment that separates organic and inorganic waste components from the waste material and that forms the organic waste component into organic slurry containing waste water, oil/grease and organic material. The organic slurry is subjected to a second separation treatment that separates the waste water, oil/grease and organic material in the organic slurry from one another. The waste water, oil/grease and organic material are subjected to further processing to produce useful products, including animal feed additives, and raw materials for cosmetics, fertilizers/composts, and renewable fuels for producing renewable energy.

### CROSS-REFERENCE TO RELATED APPLICATIONS

The present Application for Patent claims priority benefit of Provisional Application Ser. No. 61/437,837 filed Jan. 31, 2011. This provisional patent application is hereby expressly incorporated by reference herein in its entirety.

### BACKGROUND OF THE INVENTION

1. Field of the Invention

The present invention relates to techniques for processing waste materials, such as municipal solid waste (MSW) and food waste materials including FOG (fats, oils, greases) and industrial food processing residuals including DAF (dissolved air flotation) sludge, into useful products, including renewable fuels, renewable energy, animal feed additives, raw materials for cosmetics, and nutrient filled organic fertilizers and/or fertilizers/composts.

2. Background Information

The disposal of municipal solid waste (MSW) and food waste materials has become a problem for both public and private organizations, with food being the third largest portion of the United State's waste stream. Recycling programs have successfully diverted only a portion of this waste stream. Presently, the bulk of this material is either incinerated or introduced into landfills at great expense to the generators of these waste streams.

Through the years, the amount of waste generated by individual households, businesses, and governmental units has increased. Disposal of these waste materials has become more difficult. The inconvenience of waste disposal has increased along with the environmental impact of the waste on land use, potable water, the atmosphere, and the natural environment.

The traditional method of handling MSW and food waste materials has been landfilling, that is, the process of burying waste in a landfill. However, landfilling can cause environmentally unacceptable pollution discharges to the surface and ground waters, air, soil and the environment in general. Studies have shown that food waste by volume is the largest contributor of global climate change because of the release of methane and carbon dioxide from operating landfills. Furthermore, as real estate values increase, landfilling is considered to be an unattractive use of land. Thus, current waste management strategies seek to limit the amount of MSW and food waste materials directed to landfills.

Incineration, fertilizer/composting and anaerobic digestion present alternatives for handling MSW and food waste materials.

Incineration has been an inefficient way to create energy even from state of the art incinerators due to the high moisture content of food waste. It takes a lot of energy to dry the food waste material before it is ready to incinerate. In some, but not all, cases, recyclable material is removed before incineration of the waste. By incinerating things that could have been reused, resources are lost. Incinerators also release dioxins/furans, sulfur dioxide, hydrochloride, cadmium, lead, mercury, nitrogen oxide, particulate matter and carbon dioxide into the air, all of which to some extent contribute to global climate change. Furthermore, incineration can't make all the waste disappear. There is always ash left along with any non-combustible material such as metals. This waste is considered hazardous by the Environmental Protection Agency and is therefore mandated to be stored in special landfills or dedicated structures. Through the separation of organics from other contaminants like metals and plastics before the incineration process, the resultant fly ash has a high nutrient value which can be used as fertilizer. Incineration also liquefies some materials that can end up in watersheds as the waste water can't be processed by sewage treatment plants effectively. Another drawback is that incineration removes products from recycling streams and can potentially reduce the number of jobs in an area.

Anaerobic digestion presents an alternative for handling high-strength organic waste materials in both solid and liquid form. The primary objective of anaerobic digestion is the production of a mixture of methane gases (“biogas”), which may be utilized as an energy source to generate electricity and/or heat. Any solid/slurry material remaining at the completion of the anaerobic digestion process is typically disposed of by conventional landfilling or fertilizer/composting (after dewatering) or land application depending on remaining contaminants within the solid/slurry mix. However, anaerobic digestion is associated with high capital costs and inefficiencies. In addition, due to the high oil and grease content of the food waste feedstock, which can range from 10% to 35%, it can have a negative impact to the anaerobic digestion process which requires specific carbon to nitrogen ratios for effective biogas production. By extracting these oils and greases from the raw feedstock, the anaerobic digestion process will become more efficient, produce more biogas and be less costly to operate.

Composting has become a preferred method in the United States for the management and re-use of organic waste materials generated in rural and suburban settings. However, the growing use of fertilizer/composting as a preferred alternative to disposal of waste material has also created some environmental problems. These problems include emissions of noxious gases and ozone pre-cursors, runoff from the fertilizer/compost facility, and high energy consumption during material processing. These problems may become particularly acute if the waste material contains large amounts of food waste or other high organic content waste. Due to its moisture content (i.e., about 70%), food waste is also the heaviest and most costly component to dispose of.

Of particular difficulty has been the disposal and processing of waste grease. One type is found in wastewaters produced from restaurants and other large scale food processing facilities containing large amounts of fats, oils and greases (hereinafter “FOG”) commonly referred to as brown grease. Another type of waste grease originates from deep fat fryer operations and is commonly referred to as yellow grease. Yet another type of waste grease originates from industrial food processing residuals including dissolved air flotation (DAF) sludge which comes from meat processing plants as they continuously wash the meat they process with water. By processing the food we eat through many steps into a consumable product, a significant amount of protein and fat (tiny slivers of meat and fat) goes into the drain with the wash-water. The wash-water is then conveyed to a treatment plant where the FOG is concentrated and skimmed off of the wastewater discharge. The removed FOG is typically referred to as DAF sludge.

While in refined form brown grease, yellow grease and DAF sludge are recognized commodities having commercial value, these have been difficult to recover, dispose of and convert into useful products and sources of energy in an efficient and economic manner.

Brown grease contains a variety of particulate matter in addition to water and fats, oils and grease, and it presents a difficult disposal problem in that it is not easily separated and refined into a usable product, and if not carefully handled, it can upset normal water treatment processes due to its high organic load. Brown grease accounts for about 300 million gallons of waste per year in the United States.

DAF sludge contains solids that have a high nutrient value which is difficult to utilize because of the characteristics of the FOG. For years processors have had problems with trying to dispose of DAF sludge, particularly due to high disposal costs. In addition, because of its concentrated nutrient content and organic load, it gets rancid quickly when stored, creating worrisome public perception for processors who desire to remain in good standing with their neighbors and customers. While various attempts have been made to address these issues, none provide a cost-efficient and controlled method for economically recovering and utilizing brown grease and DAF sludge. In general, such attempts have focused primarily on concentrating and eliminating the waste grease in FOG and DAF sludge as a costly residual of the waste treatment process and not on the potential economic value of the grease.

### SUMMARY OF THE INVENTION

Techniques are described for processing waste material, such as municipal solid waste (MSW) and raw feedstock waste grease (e.g., fryer grease, trap grease and industrial food processing residuals including DAF (dissolved air flotation) sludge) into useful products including composts, nutrient filled organic fertilizers and/or fertilizers/composts, and renewable fuels for producing various types of renewable energy. The present invention provides for the processing of the foregoing waste material into useful products in a cost effective and environmentally friendly manner.

In one aspect, the techniques are achieved by various methods for processing waste material. In one exemplary embodiment, the method begins with subjecting the waste material to a first separation treatment by which organic and inorganic waste components are separated from the waste material and the organic components are formed into organic slurry containing waste water, organic material and oil/grease. The organic shiny is then subjected to a second separation treatment by which the waste water, organic material and oil/grease in the organic slurry are separated from one another.

By the foregoing method, the waste water, organic material and oil/grease obtained by the second separation treatment are ready for further processing to obtain various useful products. For example, the separated waste water can be subjected to conventionally known water purification and anaerobic treatments to obtain a liquid fertilizer and a form of renewable energy, respectively. The separated organic material, which is in solid or semisolid form, can be used as a fertilizer/compost for landscaping, horticulture, and agriculture applications, for example. The separated oil/grease has the composition of yellow grease and/or brown grease ready for further processing to obtain a renewable fuel (e.g., a biodiesel fuel) for producing renewable energy.

In one embodiment, the waste material that is subjected to the first and second separation treatments is municipal solid waste (MSW), also called urban solid waste. MSW includes predominantly household waste (domestic waste), including food waste, with sometimes the addition of commercial wastes collected by a municipality within a given area. They are in either solid or semisolid form and generally exclude industrial hazardous waste.

In another exemplary embodiment, the method further comprises storing the organic slurry in a storing unit, such as a holding tank, prior to subjecting the organic slurry to the second separation treatment. In this embodiment, the method allows for the processing of raw feedstock waste grease (e.g., one or more of fryer grease, trap grease and industrial food processing residuals including DAF sludge) simultaneously with organic slurry that is formed during the first separation treatment and that originates from MSW. More specifically, the method comprises the introduction of raw feedstock waste grease directly into the holding tank, in which the organic slurry originating from MSW is stored, prior to the second separation treatment. The raw feedstock waste grease and organic slurry stored in the holding tank are then subjected to the second separation treatment to separate waste water, organic material and oil/grease from the mixture of raw feedstock waste grease and organic slurry. By this method, organic waste from various sources (i.e., MSW and raw feedstock waste grease) can be centrally stored prior to being subjected to the second separation treatment as set forth above.

In yet another exemplary embodiment, the method further comprises the step of introducing into the holding tank at least a second organic slurry that originates from MSW at a location different from the location of the first MSW from which the first organic slurry originates. By this method, organic waste from various sources (i.e., MSW from different locations and/or raw feedstock waste grease) can be centrally stored prior to being subjected to the second separation treatment as set forth above.

In another exemplary embodiment, the method according to the present invention comprises subjecting only food processing residuals including DAF sludge to a separation treatment by which waste water, organic material and oil/grease in the food processing residuals are separated from one another. In a modification to this embodiment, the food processing residuals are stored in a storing unit, such as a holding tank, prior to being subjected to the separation process.

In yet another exemplary embodiment, the method according to the present invention comprises the following steps: receiving MSW from a first source; receiving food processing residuals including DAF sludge from a second source different from the first source, the food processing residuals containing waste water, organic material and oil/grease; subjecting the received MSW to a first separation treatment to separate the organic and inorganic waste components from MSW and form the organic waste components into an organic slurry containing waste water, organic material and oil/grease; and subjecting the organic slurry and the received food processing residuals to a second separation treatment to separate the waste water, organic material and oil/grease from one another. In a modification to this embodiment, the organic slurry and the food processing residuals are stored in a storing unit, such as a holding tank, prior to being subjected to the second separation treatment.

In another aspect, the present invention is directed to systems for performing the foregoing methods and corresponding steps according to the present invention. According to an exemplary embodiment, the system comprises a first separating device that separates organic and inorganic waste components from the waste material (e.g., MSW) and forms the organic waste component into organic slurry containing waste water, organic material, and oil/grease, and a second separating device that separates the waste water, organic material and oil/grease in the organic slurry from one another.

In another exemplary embodiment, the system further comprises a storing unit, such as a holding tank, disposed between the first and second separating devices to store the organic slurry prior to separation by the second separating device. By this construction, the holding tank is configured and functions as a centralized holding tank that stores waste material from various sources (e.g., various municipal transfer stations and independent haulers) prior to simultaneous processing of the waste material by the second separating device to obtain useful products, including nutrient filled organic fertilizers and/or fertilizers/composts and renewable fuels for producing renewable energy.

### BRIEF DESCRIPTION OF THE DRAWINGS

FIG. 1A is a schematic of the process in accordance with one exemplary embodiment of the invention.

FIG. 1B is a schematic of a modified form of the process in accordance with the exemplary embodiment of the invention shown in FIG. 1A.

FIG. 1C is a schematic of a modified form of the process in accordance with the exemplary embodiment of the invention shown in FIG. 1B.

FIG. 2 is a schematic of the process in accordance with another exemplary embodiment of the invention.

FIG. 3 is a schematic of the process in accordance with another exemplary embodiment of the invention.

FIG. 4 is a schematic of the process in accordance with another exemplary embodiment of the invention.

FIG. 5 is a schematic of the process in accordance with another exemplary embodiment of the invention.

FIG. 6 is a schematic of the process in accordance with another exemplary embodiment of the invention.

FIG. 7 is a schematic of the process in accordance With another exemplary embodiment of the invention.

FIG. 8 is a schematic of the process in accordance with another exemplary embodiment of the invention.

FIG. 9 is a schematic of the process in accordance with another exemplary embodiment of the invention.

FIG. 10 is a schematic of the process in accordance with another exemplary embodiment of the invention.

FIG. 11 is a schematic of the process in accordance with another exemplary embodiment of the invention.

FIG. 12 is a schematic of the process in accordance with another exemplary embodiment of the invention.

FIG. 13 is a schematic of the process in accordance with another exemplary embodiment of the invention.

FIG. 14 is a schematic of the process in accordance with another exemplary embodiment of the invention.

FIG. 15 is a schematic of the process in accordance with another exemplary embodiment of the invention.

FIG. 16 is a schematic of the process in accordance with another exemplary embodiment of the invention.

FIG. 17 is a schematic of the process in accordance with another exemplary embodiment of the invention.

FIG. 18 is a schematic of the process in accordance with another exemplary embodiment of the invention.

FIG. 19 is a schematic of the process in accordance with another exemplary embodiment of the invention.

FIG. 20 is a schematic of the process in accordance with another exemplary embodiment of the invention.

FIG. 21 is a schematic of a system in accordance with an exemplary embodiment of the invention.

FIG. 22 is a schematic of a system in accordance with another exemplary embodiment of the invention.

FIG. 23 is a schematic of a system in accordance with an exemplary embodiment of the invention.

FIG. 24 is a schematic of a system in accordance with another exemplary embodiment of the invention.

FIG. 25 is a schematic of a method in accordance with another exemplary embodiment of the invention.

FIG. 26 is a schematic of a method in accordance with another exemplary embodiment of the invention.

### DETAILED DESCRIPTION OF THE PREFERRED EMBODIMENTS

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The detailed description includes specific details for the purpose of providing a thorough understanding of the exemplary embodiments of the invention. It will be apparent to those skilled in the art that the exemplary embodiments of the invention may be practiced without these specific details.

For purposes of this disclosure:
Municipal solid waste (MSW), also called urban solid waste, is a type of waste that includes predominantly household waste (domestic waste), including food waste, with sometimes the addition of commercial wastes collected by a municipality within a given area. MSW is generally in solid or semisolid form and generally excludes industrial hazardous waste.
MSW facility includes, but is not limited to, transfer stations and landfills.
Vegetable oils and fats are those which originate predominantly from vegetable starting materials, such as seeds, roots, leaves or other suitable plant parts.
Animal fats or oils originate predominantly from animal starting materials, such as animal organs, tissues or other body parts or body fluids, such as milk.
Industrial oils and fats are those originating particularly from animal or vegetable starting materials and treated for technical purposes.
Soapstock is understood as meaning a byproduct obtained in the processing of vegetable oils, in particular a byproduct of edible oil refineries which is based on soybean, colza or sunflower oil.
Brown grease or trap grease is a type of waste grease found in wastewaters produced from restaurants and other large scale food processing facilities containing large amounts of fats, oils and greases (FOG).
Yellow grease is a type of waste grease that originates directly from deep fat fryers (fryer grease) and other cooking equipment. Yellow grease also refers to lower-quality grades of tallow from rendering plants.
Industrial food processing residuals including DAF (dissolved air flotation) sludge are types of waste originating from meat processing plants as they continuously wash the meat they process with water.
Industrial tallow and industrial lard are understood as meaning animal fats which are produced for industrial purposes and are obtained after the drying or wet melting process, for example from slaughter wastes.
Raw feedstock waste grease refers to waste grease originating from fryer grease, trap grease and/or industrial food processing residuals including DAF sludge or any other organic material containing FOG material.

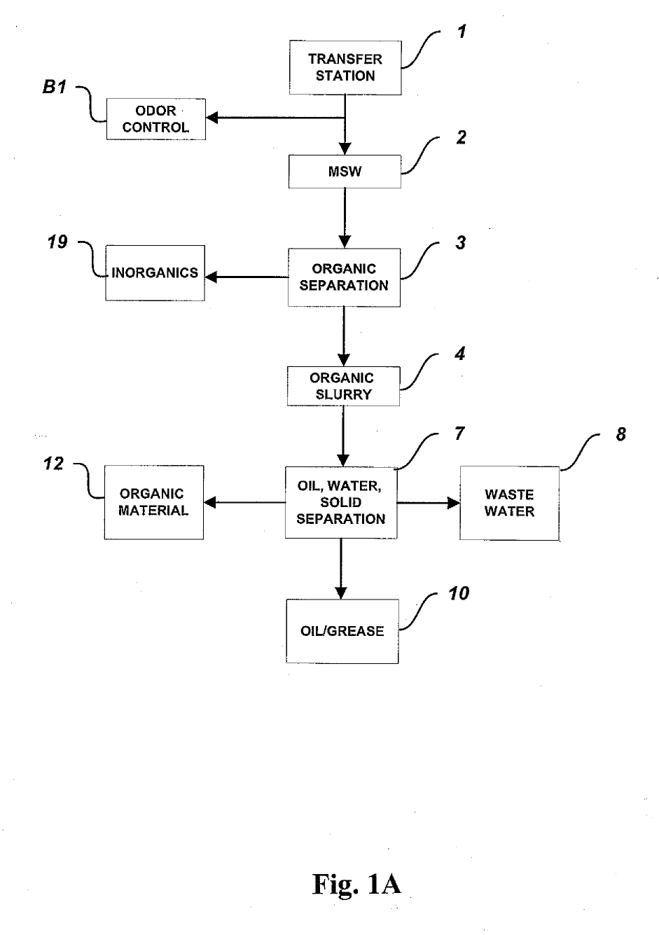

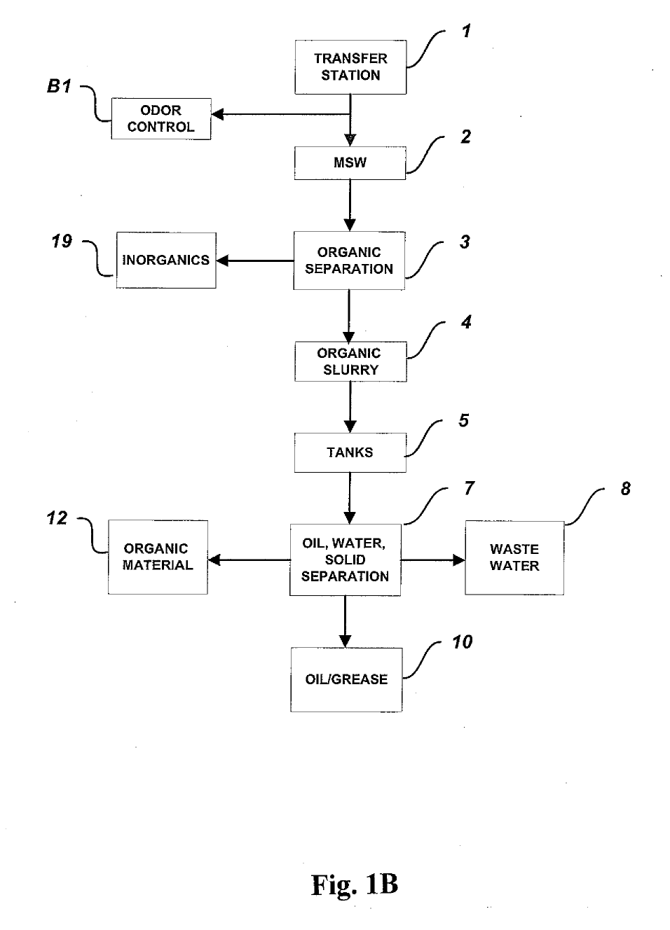

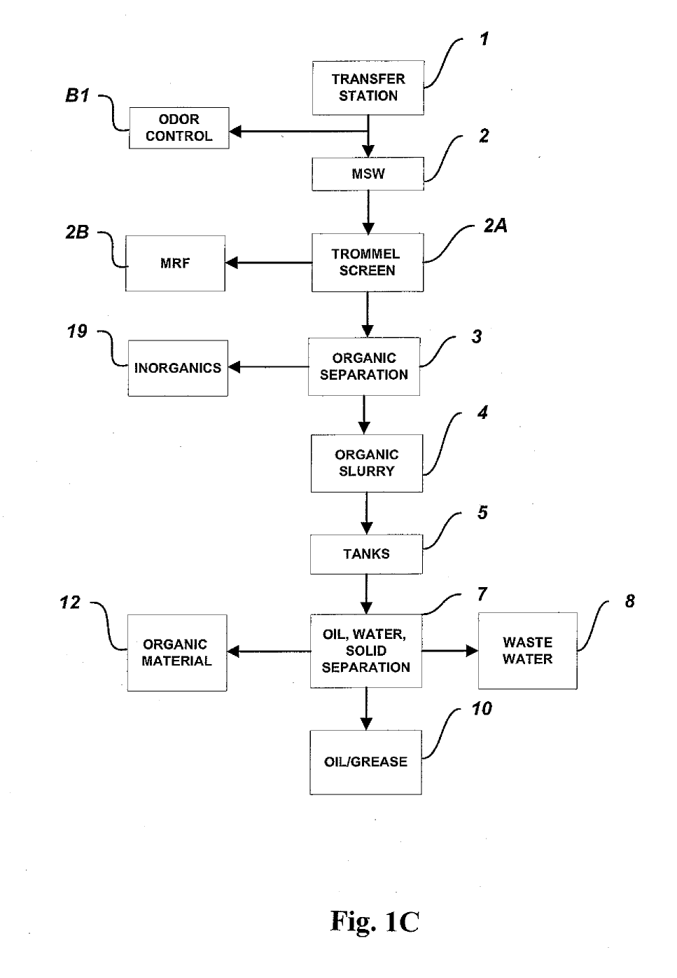

Exemplary embodiments of the techniques according to the present invention are described below with reference to FIGS. 1-24.

FIG. 1A is a process flow diagram illustrating an exemplary embodiment of the invention. Municipal solid waste (MSW) 2 is delivered (e.g., by municipal garbage trucks) to a MSW facility, such as on a tipping floor of a transfer station 1, and the MSW is manually sorted to remove large recyclable materials and reject materials, such as tires, cardboard, bicycles, etc. Prior to or after the manually sorting step, the MSW is subjected to an optional odor control treatment B1. The rest of the MSW 2 is then subjected to an organic separation process 3 whereby the MSW 2 inorganics 19 are separated from organics. In the organic separation process 3, the organics are ground down to a slurry type product 4 (organic slurry) while inorganics 19 (e.g., glass, plastics, metals, clothes, cans, wood, etc.) are diverted onto a small picking station to be sorted, bailed, or compacted for disposal. The organic slurry 4 thus formed is then subjected to a separation treatment 7 in which organic slurry 4 is separated into waste water 8, oil/grease (hereinafter collectively “oil”) 10 and solid organic material 12. The resulting oil 10 has the consistency of yellow grease and/or brown grease, final commodities which can be marketed and/or subjected to further processing to obtain a renewable fuel as further described below.

Yellow grease is distinct from brown grease, as yellow grease is typically used-frying oils from deep fryers, whereas brown grease is sourced from grease traps and grease interceptors. A grease trap is a small volume devices located inside a food service facility, generally under a sink, designed to collect, contain, or remove floating food wastes and brown grease from the waste streams while allowing the balance of liquid waste to discharge into the wastewater collection system, usually a sanitary sewer system. A grease interceptor is a large volume device located underground and outside of a food service facility designed to collect, contain or remove food wastes and brown grease from the waste stream while allowing the balance of the liquid waste to discharge to the wastewater collection system, usually a sanitary sewer system.

Yellow grease is recovered, traded as a marginally valuable commodity, and has traditionally been used as an animal feed additive to spray on roads as dust control, but has become a feedstock for biodiesel production. Although most biodiesel is produced from renewable plant sources, yellow grease is attractive because it is inexpensive and its use converts waste into fuel.

The organic separation process 3 in the present embodiment is accomplished utilizing an organics processing system including a separation device (first separation device) specialized to take the MSW 2 with or without plastic bags, cardboard, wood, glass and other contaminants and to process it into an organic slurry free of inorganics. One such organics processing system is commercialized by DODA Costruzione Macchine Agricole, Italy, and is incorporated herein by reference in its entirety.

The separation treatment 7 is accomplished utilizing an oil extraction system including a separation device (second separation device) specialized in extracting oil 10 from organic slurry 3 by separating waste water 8, oil 10, and organic material 12 from one another. One such oil extraction system is commercialized by Renewable BioSystems, LLC, New Jersey, and is incorporated herein by reference in its entirety.

Although described herein in connection with a transfer station, it will be appreciated that the MSW may originate from other types of MSW facilities, such as landfills. Additionally, waste material may be other than MSW, such as source separated organic waste. Source separated organic waste material is waste material that is source separated before being brought to the facility, meaning that at the point of collection organic waste material has been segregated from inorganic waste material. Source separated organic waste material can comprise, for example, food waste, and can be derived from both residential and commercial sources.

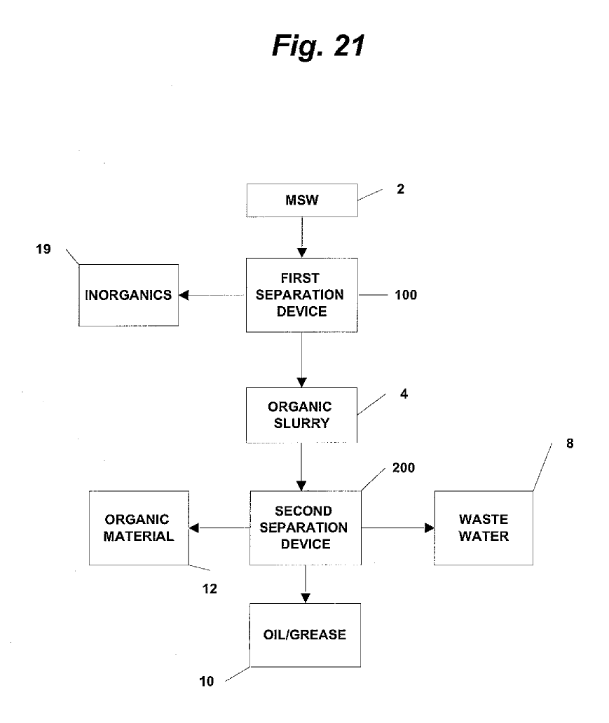

FIG. 21 is a schematic of an exemplary embodiment of a system for implementing separation treatments 3 and 7 shown in FIG. 1A. A first separation device 100 receives MSW 2, performs separation treatment 3 in FIG. 1A to separate organics from inorganics 19 in MSW 2, and forms the separated organic material into organic slurry 4. A second separation device 200 receives organic slurry 4 and performs separation treatment 7 in FIG. 1A to separate organic slurry 4 into waste water 8, oil/grease 10 and organic material 12 as described above.

Organic separation 3 performed by first separation device 100 and separation treatment 7 performed by second separation device 200 can be a continuous process whereby organic slurry 4 produced is introduced directly into separation device 200. Alternatively, organic slurry 4 is first delivered into a storing unit, such as a holding tank, prior to introduction into separation device 200 for separation treatment 7, as further described below with reference to a modified embodiment shown in FIG. 1B.

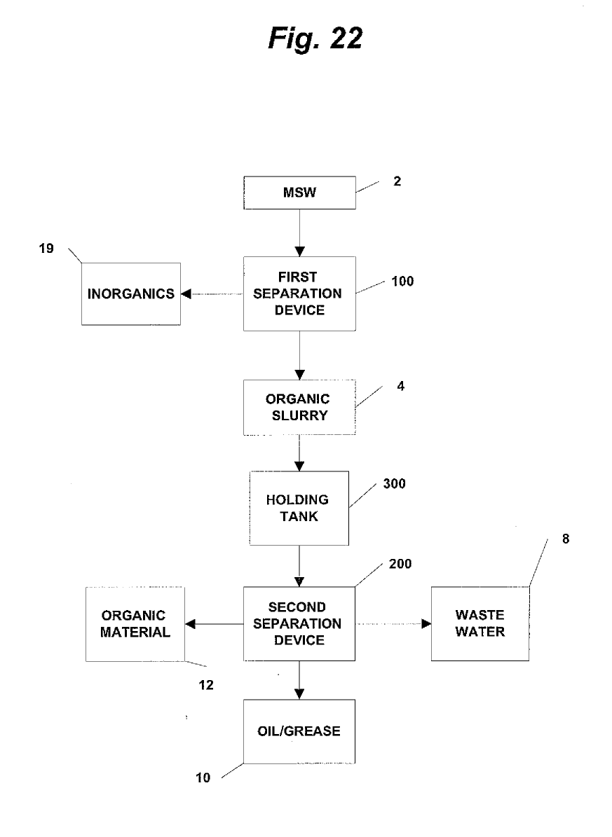

FIG. 1B is a process flow diagram illustrating a modification to the process shown in FIG. 1A. In this modified embodiment, organic slurry 4 produced by organic separation 3 is stored in one or more storing units, such as the tank(s) designated by numeral 5, prior to being subjected to separation treatment 7. FIG. 22 is a schematic of an exemplary embodiment of a system for implementing the process in FIG. 1B. The tank denoted at 5 in FIG. 1B is a holding tank 300 for storing organic slurry 4 prior to it being introduced into second separation device 200. Holding tank 300 is structured separately and independently from first separation device 100 and second separation device 200 and may be an in-situ aboveground or underground tank positioned so as to interconnect between first separation device 100 and second separation device 200. Alternatively, holding tank 300 may be a mobile storage tank, such as a storage tank incorporated in a vehicle, which is selectively movably positioned for interconnection between the first and second separation devices 100, 200. Holding tank 300 may be formed of plastic reinforced with glass fiber, or any other suitable material(s). All other aspects of the process and system in FIGS. 1B and 22 are as described above in connection with FIGS. 1A and 21.

FIG. 1C is a process flow diagram illustrating a modification to the process shown in FIG. 1B. In this modified embodiment, MSW 2 is introduced into a screening apparatus, such as a trommel screen 2A, prior to being subjected to organic separation 3. Trommel screen 2A separates MSW 2 by size, with larger components of MSW 2 being directed to a material recovery facility (MRF) 2B. The separation of MSW 2 by trommel screen 2A is performed in place of or after the manual sorting step to remove large recyclable materials and reject materials from MSW 2 as described above. All aspects of the process and system are as described above in connection with FIGS. 1B and 22. It is understood that the structure and corresponding functions of trommel screen 2A can also be incorporated into the process and system described above in connection with FIGS. 1A and 21. Alternatively, instead of trommel screen 2A, the screening apparatus may be, for example, a screening table, a perforated plate, or a shaker screen.

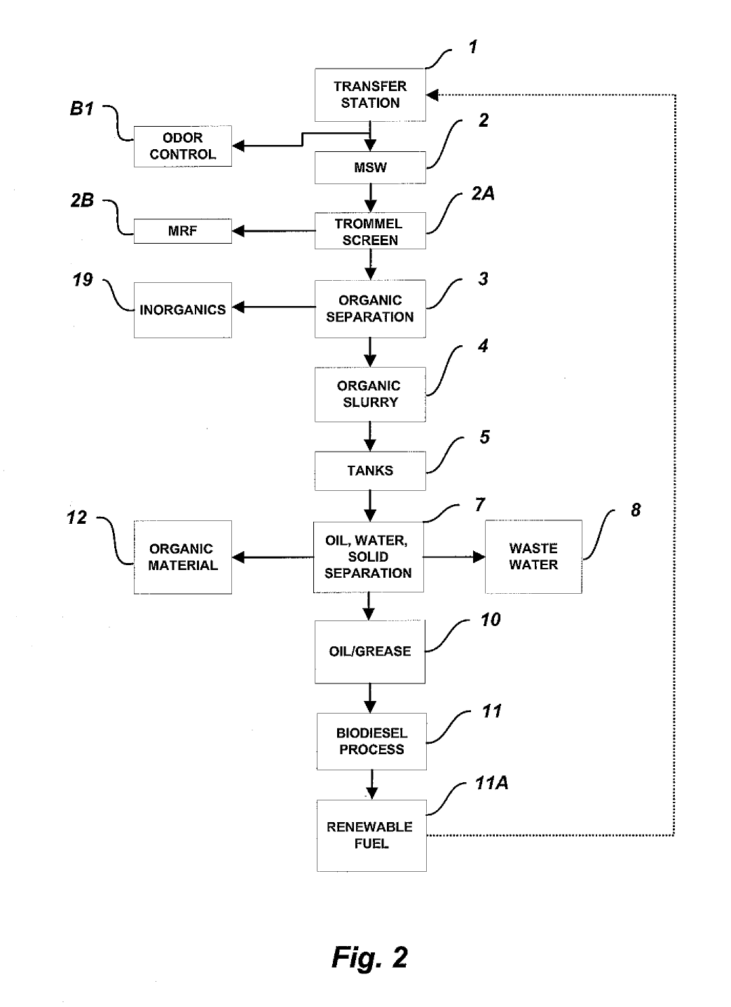

FIG. 2 is a process flow diagram illustrating another embodiment of the present invention which is the same as described above for the embodiment of FIG. 1C except for further processing of oil 10 generated by separation treatment 7. More specifically, after separation treatment 7, oil 10 (e.g., yellow/brown grease) is subjected to a biodiesel process 11 whereby the oil is refined to produce renewable fuel 11A in the form of a high quality biodiesel fuel.

The biodiesel process 11 is accomplished utilizing a biodiesel production system specialized in refining the separated or extracted oil 10 to produce a finished biodiesel product as a renewable fuel that can be used as a source for running a heater, boiler and/or an engine within the system of the present invention (as denoted in dashed line in FIG. 2), or that can be marketed for sale. One such biodiesel production system is commercialized by U.S. Alternative Fuels Corp., PA, and is incorporated herein by reference in its entirety.

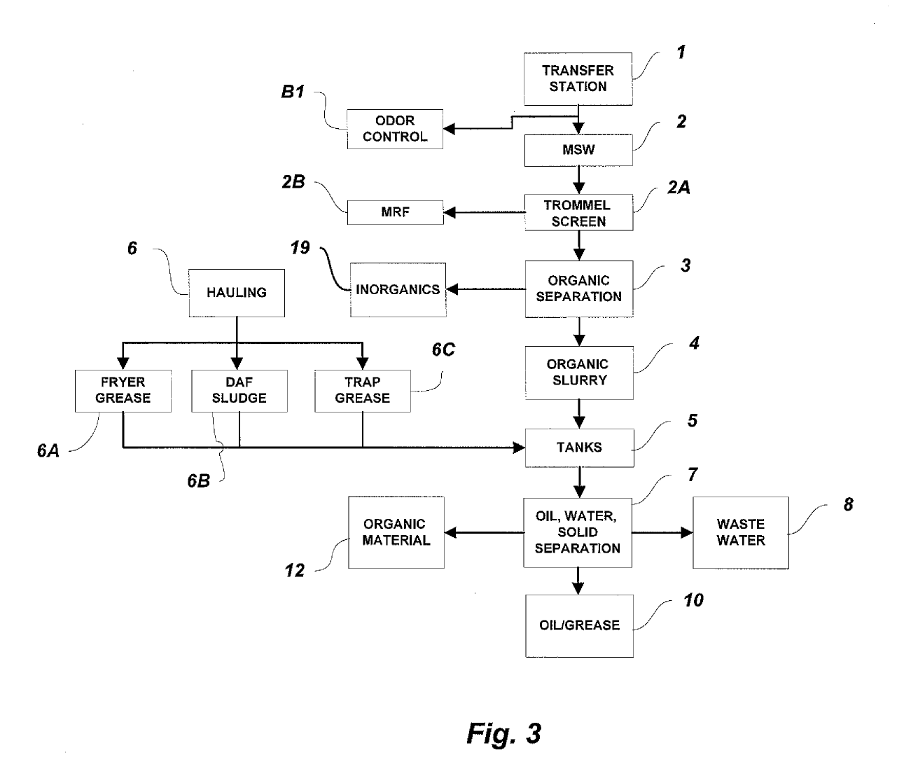

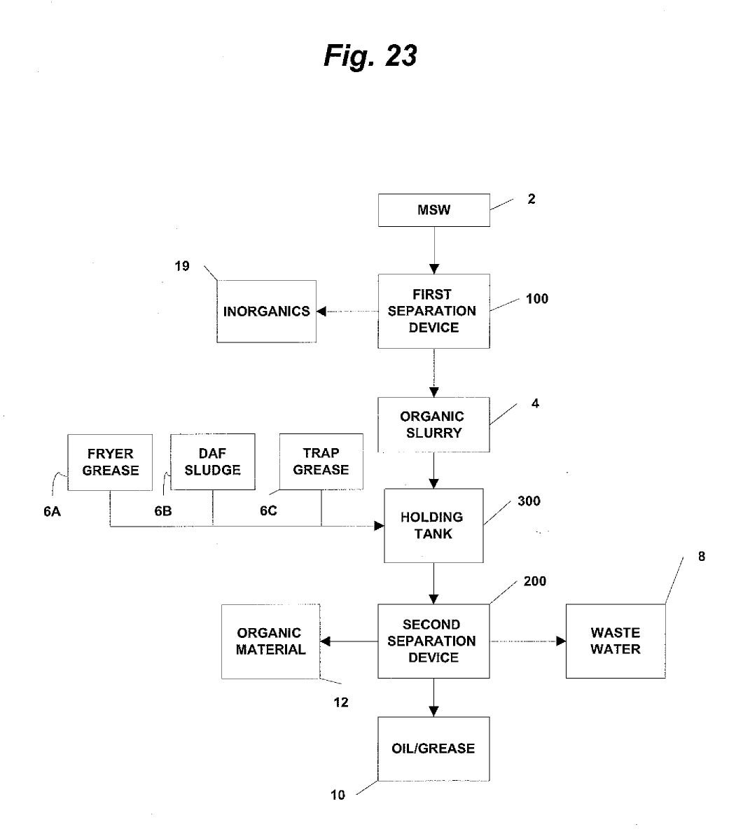

FIG. 3 is a process flow diagram illustrating another embodiment of the method of the present invention which is the same as described above for FIG. 1C except for the additional introduction of raw feedstock waste grease for processing with organic slurry 4 by separation treatment 7. FIG. 23 is a schematic of an exemplary embodiment of a system for implementing the process in FIG. 3. The raw feedstock waste grease is one or more of fryer grease 6A, industrial food processing residuals including DAF sludge 6B, and trap grease 6C.

Raw feedback waste grease 6A-6C is introduced directly into holding tank 300 without subjecting the waste grease to trommel screen 2A and organic separation process 3 as described above for MSW 2. For example, a hauling company 6 brings the raw feedstock waste grease for processing by introducing (pumping) it directly into centralized holding tank 300. The raw feedstock waste grease is thus stored in holding tank 300 along with organic slurry 4, where they await to undergo separation treatment 7 by second separation device 200 as described above.

By the method and system according to this embodiment, the holding tank 300 functions as a centralized holding tank for storing organic slurry 4, originating from MSW 2 at transfer station 1, and raw feedstock waste grease 6A-6C (e.g., originating from a location different than transfer station 1) hauled in and introduced directly into centralized holding tank 300. Organic slurry 4 and raw feedstock waste grease 6A-6C can then be simultaneously subjected to separation treatment 7 to obtain waste water 8, oil 10 and organic material 12 as described above.

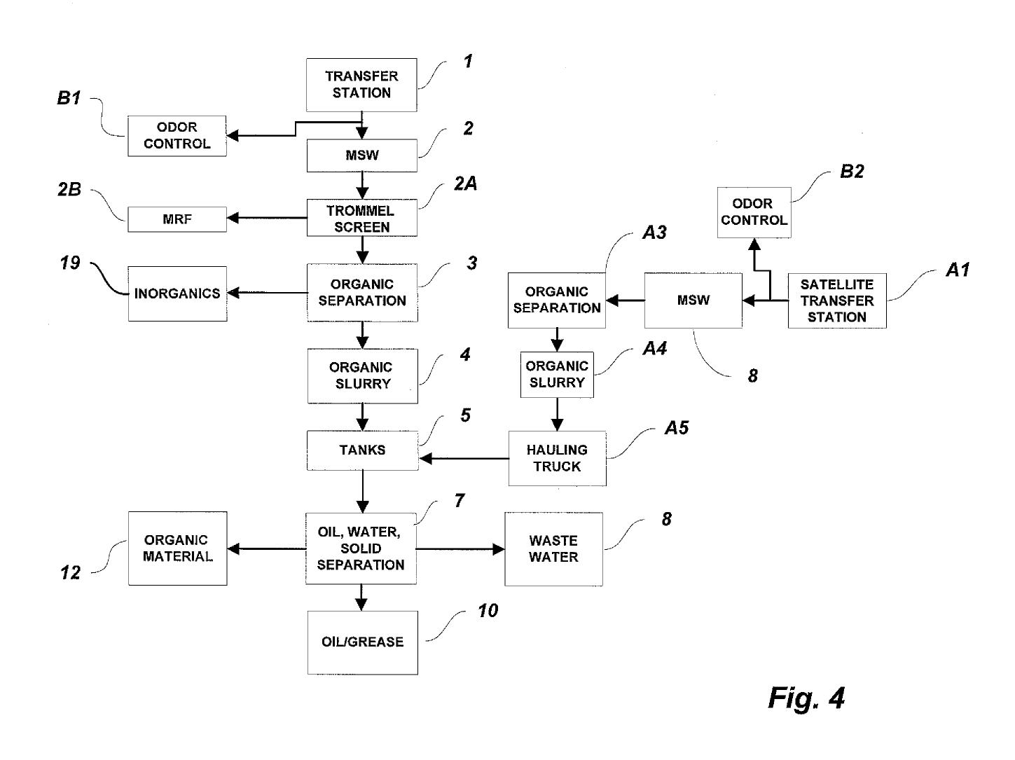

FIG. 4 is a process flow diagram illustrating another embodiment of the present invention which is the same as described above for FIG. 1C except for the introduction of organic slurry A4, which is processed from MSW originating from a satellite transfer station A1, directly into storage tank 5. Organic slurry A4 is produced substantially the same as described above for organic slurry 4. That is, MSW A2 from satellite transfer station A1 is subjected to an optional odor control treatment B2 and then manually sorted and/or subjected to a trommel screen (not shown). MSW A2 remaining after sorting/screening is then subjected to organic separation A3, whereby inorganics (not shown) are separated from organics which are ground down to form organic slurry A4 that is hauled by hauling truck AS and introduced directly into storage tank 5 containing organic slurry 4. In storage tank 5, organic slurry 4 and organic slurry A4 await processing by separation treatment 7 as described above.

By this process and system, the storage of organic slurry 4 and organic slurry A4 originating from MSW 2 and MSW A2, respectively, at different transfer stations can be centralized via holding tank 300, as described above with reference to FIGS. 3 and 23. The stored organic slurries 4 and A4 are then simultaneously subjected to separation treatment 7 by second separation device 200 as described above.

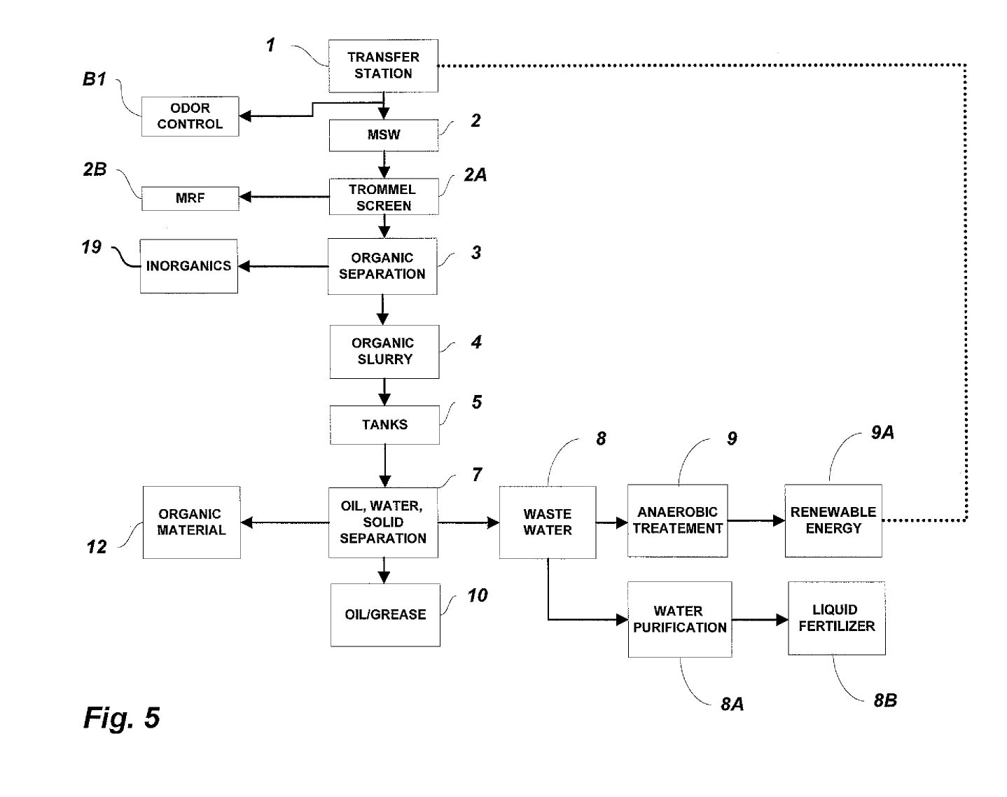

FIG. 5 is a process flow diagram illustrating a method according to another embodiment of the present invention which is the same as described above for the embodiment of FIG. 1C except for further processing of waste water 8 produced by separation treatment 7.

Waste water 8 is subjected to a water purification treatment 8A by a water purification unit to remove nitrogen based compounds which can then be safely disposed of or used as a liquid fertilizer 813. Additionally or alternatively, waste water 8 is pumped into a conventional anaerobic digestion system for anaerobic treatment 9 to generate renewal energy 9A that can be used as a source for running a heater, boiler and/or an engine within the system of the present invention, or that can be marketed for sale.

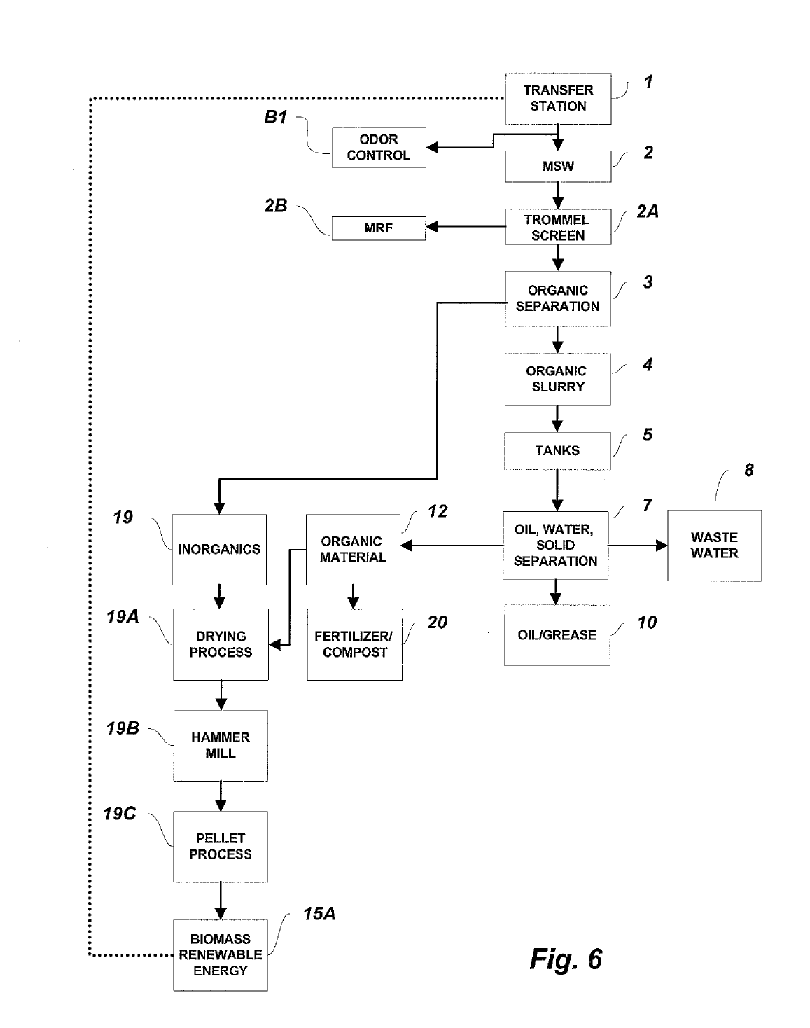

FIG. 6 is a process flow diagram illustrating another embodiment of the present invention which is the same as described above for the embodiment of FIG. 1C except for further processing of organic material 12 obtained from separation treatment 7 and further processing of inorganics 19 obtained from organic separation 3.

Organic material 12 obtained from separation treatment 7 has a solid or semisolid consistency suitable for use as a fertilizer/compost 20. Additionally or alternatively, organic material 12 is subjected to a drying process 19A and introduced into hammer mill 19B in which organic material 12 is ground. Thereafter, the ground organic material 12 is subjected to a pellet process 19C in a pellet machine and processed into a final product (pellets) as a renewable fuel from which renewable energy 15A can be produced (e.g., by heating the pellets) and used as a source of energy for operating a heater, boiler and/or an engine within the system of the present invention (as depicted in dashed line in FIG. 6), or that can be marketed for sale.

Inorganic material 19 obtained from organic separation 3 is similarly subjected to drying process 19A, hammer mill 19B, and pellet process 19C in a pellet machine and processed into a final product (pellets) as a renewable fuel from which renewable energy 15A can be produced (e.g., by heating the pellets) and used as a source of energy for operating a heater, boiler and/or an engine within the system of the present invention (as depicted in dashed line in FIG. 6), or that can be marketed for sale.

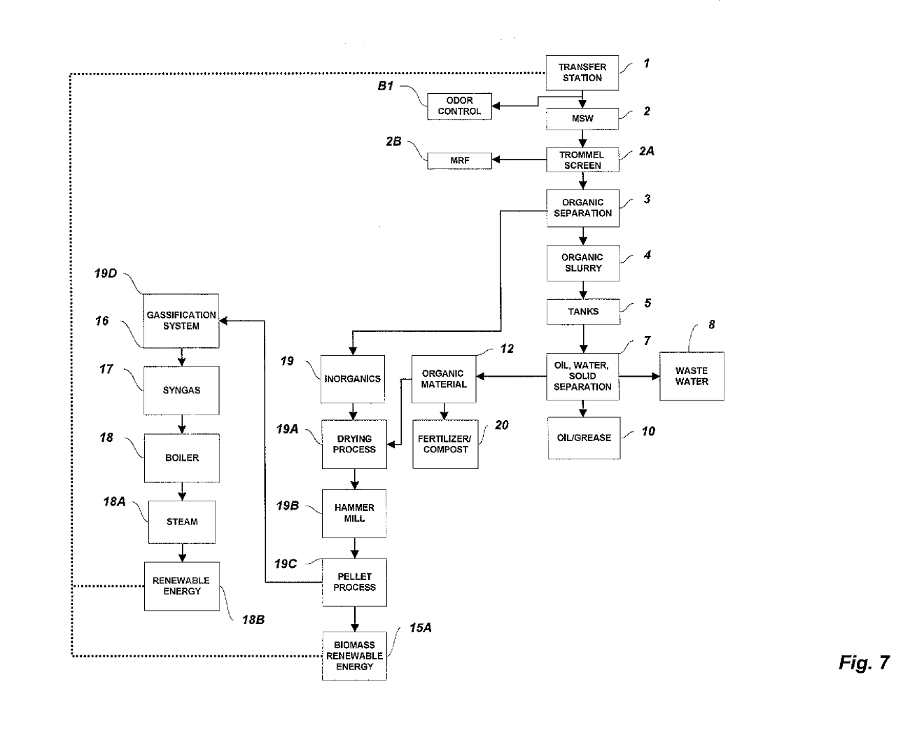

FIG. 7 is a process flow diagram illustrating a method according to another embodiment of the present invention which is the same as described above for the embodiment of FIG. 6 except for further processing of the pellets produced in the pellet process 19C to obtain a form of renewable fuel for producing yet another form of renewable energy.

The pellets produced in the pellet process 19C are processed by a gassification system 19D to generate syngas (synthetic gas) 17 as a renewable fuel that can be used to operate a boiler 18 or other system to produce steam 18A from which renewal energy 18B is produced. Syngas 17 and renewable energy 18B can be used as sources of energy for operating a heater, boiler and/or an engine within the system of the present invention (as depicted in dashed line in FIG. 7). Alternatively or additionally, syngas 17 and/or renewable fuel 18B can be marketed for sale for a similar or other suitable use.

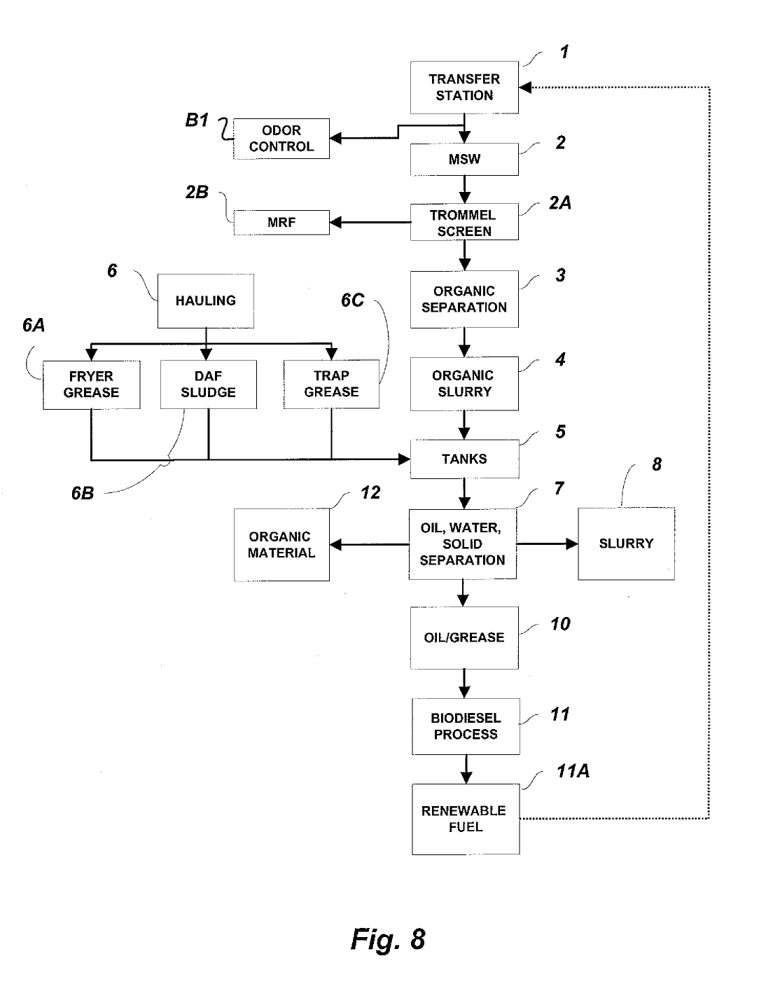

FIG. 8 is a process flow diagram illustrating a method according to another embodiment of the present invention. FIG. 8 is the same as the process described above with reference to the embodiment of FIG. 2 in which oil 10 produced by separation treatment 7 is subjected to a biodiesel process 11 whereby the oil is refined to produce renewable fuel 11A in the form of a high quality biodiesel fuel. Additionally, in FIG. 8 raw feedstock waste grease 6A-6C is introduced into storage tank 5 to await processing by separation treatment 7 together with organic slurry 4, as described above with reference to the method shown in FIG. 3 and corresponding system shown in FIG. 23.

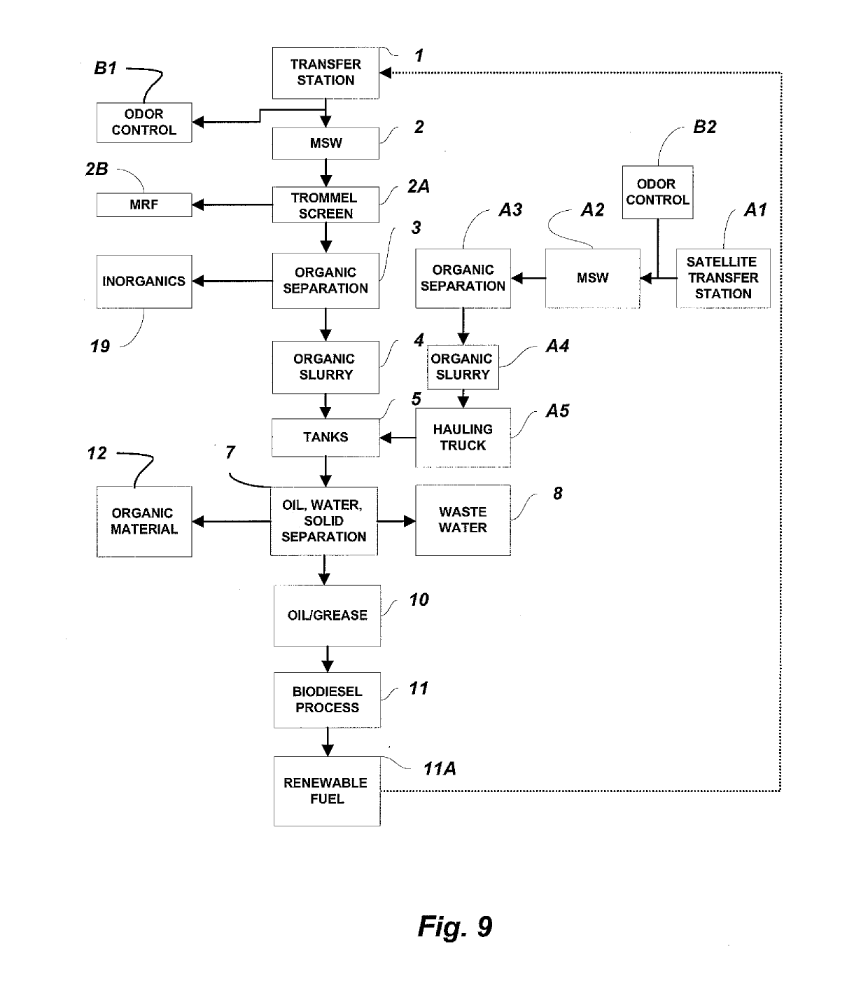

FIG. 9 is a process flow diagram illustrating a method according to another embodiment of the present invention. In FIG. 9, oil 10 produced by separation treatment 7 is subjected to biodiesel process 11 whereby the oil is refined to produce renewable fuel 11A in the form of a high quality biodiesel fuel, as described above with reference to the embodiment of FIG. 2. Additionally, in FIG. 9 organic slurry A4 originating from MSW A2 at satellite transfer station A1 is directly introduced into storage tank 5 and, together with organic slurry 4, await processing by separation treatment 7 as described above with reference to the embodiment of FIG. 4.

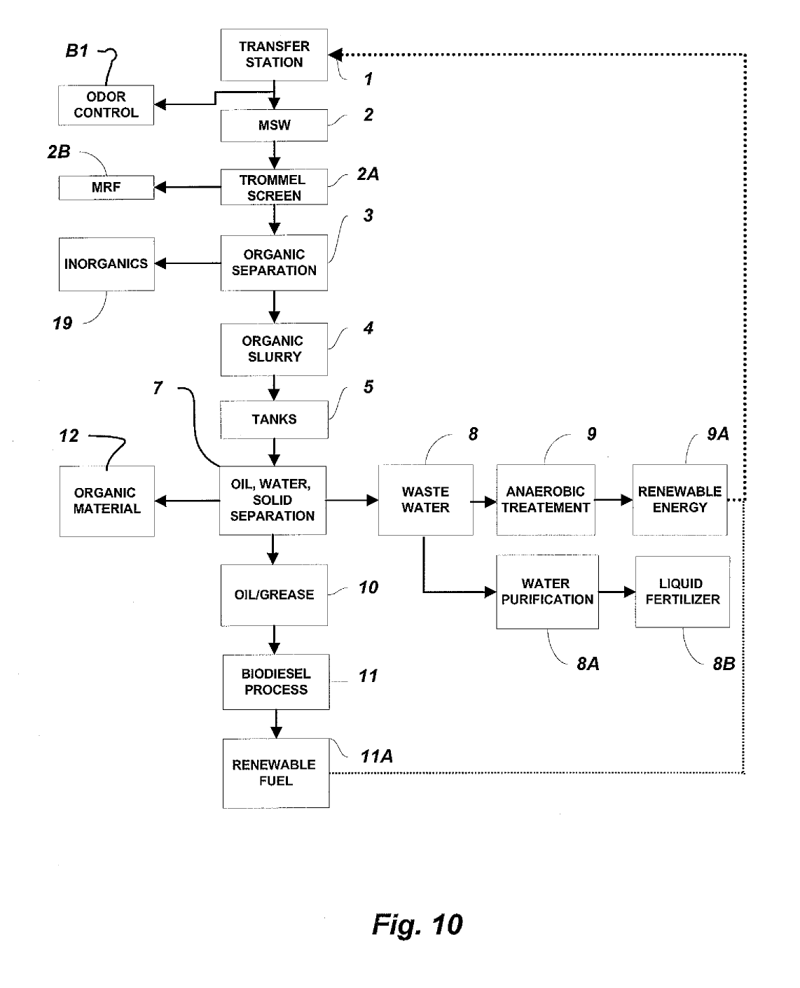

FIG. 10 is a process flow diagram illustrating another embodiment of the present invention. In FIG. 10, oil 10 produced by separation treatment 7 is subjected to biodiesel process 11 whereby the oil is refined to produce renewable fuel 11A in the form of a high quality biodiesel fuel, as described above with reference to the embodiment of FIG. 2. Additionally, in FIG. 10 waste water 8 produced by separation treatment 7 is subjected to processing to produce liquid fertilizer 8B and renewable energy 9A as described above for the embodiment of FIG. 5.

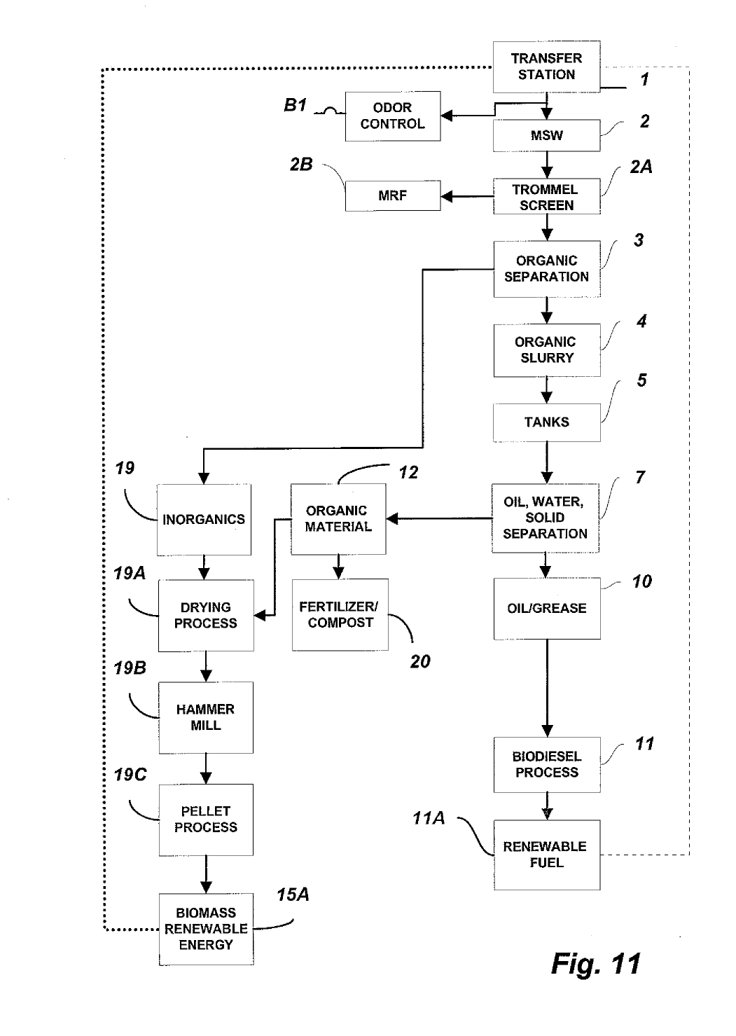

FIG. 11 is a process flow diagram illustrating a method according to another embodiment of the present invention. In FIG. 11, oil 10 produced by separation treatment 7 is subjected to biodiesel process 11 whereby the oil is refined to produce renewable fuel 11A in the form of a high quality biodiesel fuel, as described above with reference to the embodiment of FIG. 2. Additionally, in FIG. 11 organic material 12 and inorganics 19 are further processed to obtain additional usable products including fertilizer/compost 20 and renewable fuel (e.g., pellets) for producing renewable energy 15A, as described above with reference to FIG. 6.

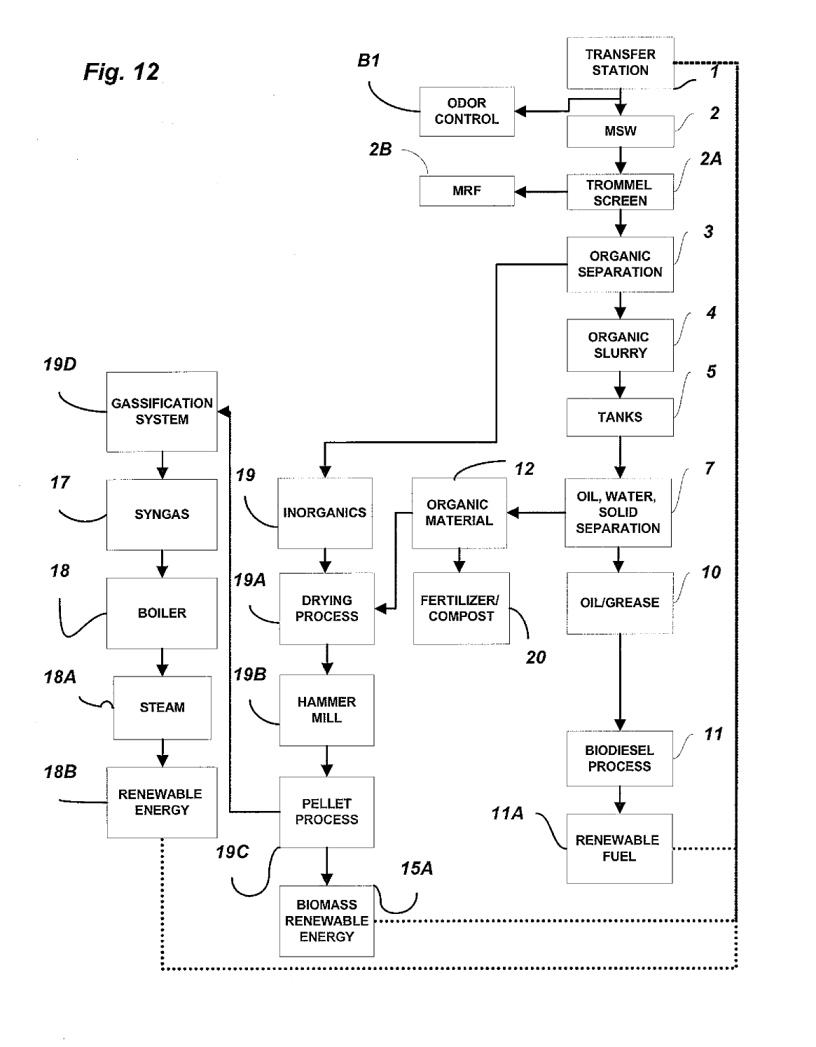

FIG. 12 is a process flow diagram illustrating a method according to another embodiment of the present invention. FIG. 12 is the same as the process described above with reference to the embodiment of FIG. 7 in which organic material 12 and inorganics 19 are further processed to produce additional usable products including fertilizer/compost 20, renewable energy 15A, syngas 19D and renewable energy 18B, as described above with reference to FIG. 7. Additionally, oil 10 produced by separation treatment 7 is subjected to biodiesel process 11 whereby the oil is refined to produce renewable fuel 11A in the form of a high quality biodiesel fuel, as described above with reference to the embodiment of FIG. 2.

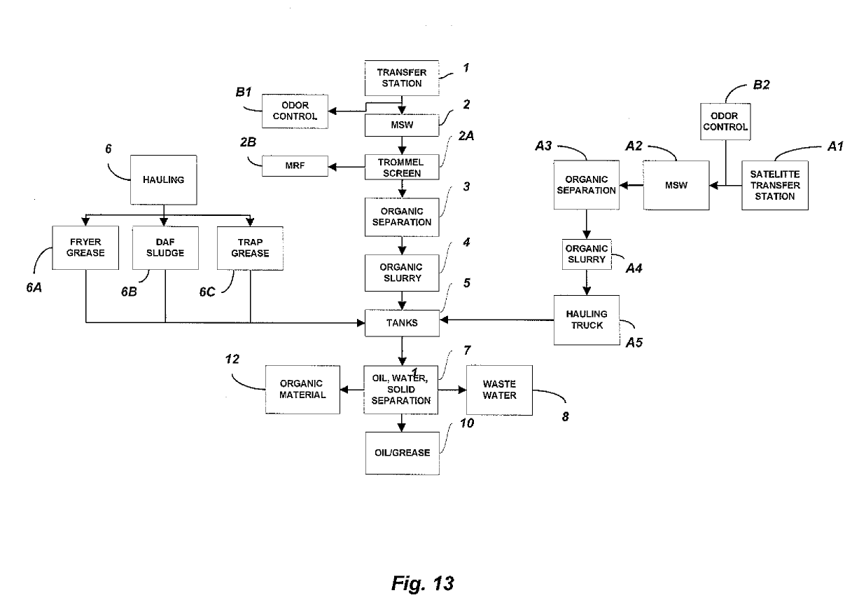

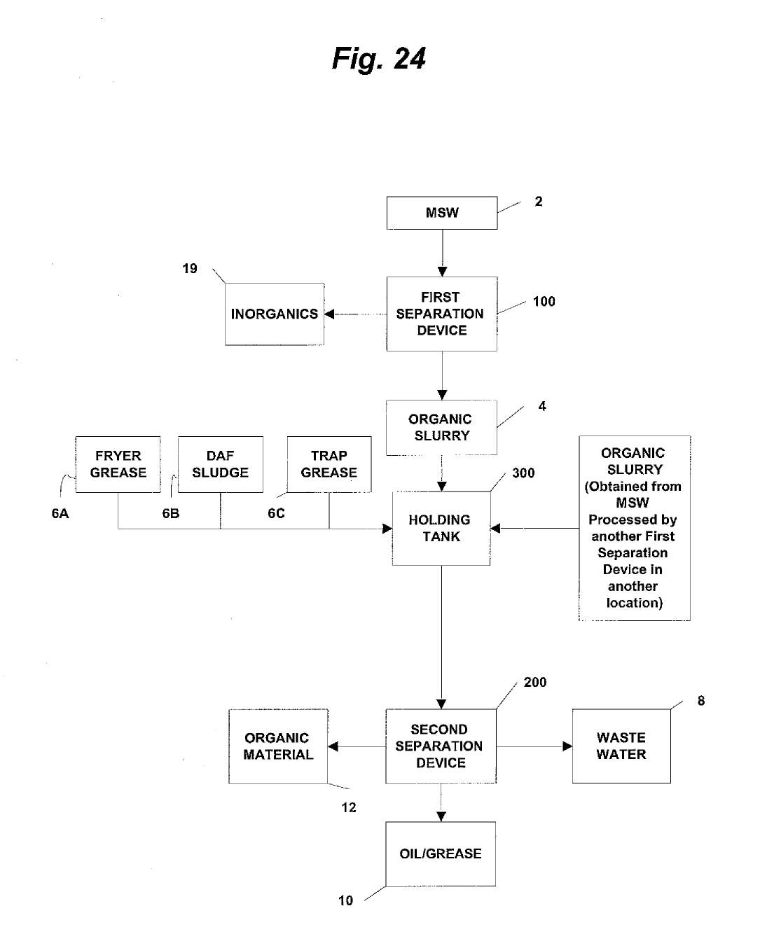

FIG. 13 is a process flow diagram illustrating a method according to another embodiment of the present invention. FIG. 24 is a schematic of an exemplary embodiment of a system for implementing the process in FIG. 13.

The process in FIG. 13 is the same as described above with reference to the embodiment of FIG. 3 and corresponding system shown in FIG. 23, in which raw feedstock waste grease 6A-6C is introduced into holding tank 300 storing organic slurry 4, and after which feedstock waste grease 6A-6C and organic slurry 4 are subjected to separation treatment 7 by second separation device 200, as described above. Additionally, in the process of FIG. 13 organic slurry A4 produced from MSW A2 originating from satellite transfer station A1 is also stored into holding tank 300 together with organic slurry 4 and raw feedstock waste grease 6A-6C. Thereafter, organic slurry 4, organic slurry A4 and raw feedstock waste grease 6A-6C are simultaneously subjected to separation treatment 7 by second separation device 200 to separate waste water 8, oil 10 and organic material 12, as described above.

According to the foregoing process and system, the holding tank 300 functions as a centralized storing unit, such as a holding tank, capable of simultaneously storing organic slurry originating from MSW at different transfer stations along with raw feedstock waste grease. The stored organic slurries and raw feedstock waste grease can then be simultaneously subjected to separation treatment 7 by second separation device 200 to obtain waste water 8, oil 10 and organic material 12, as described above. Thus processing of the foregoing waste material to obtain waste water 8, oil 10 and organic material 12 is achieved in an efficient, economic, environmentally friendly, and controlled manner.

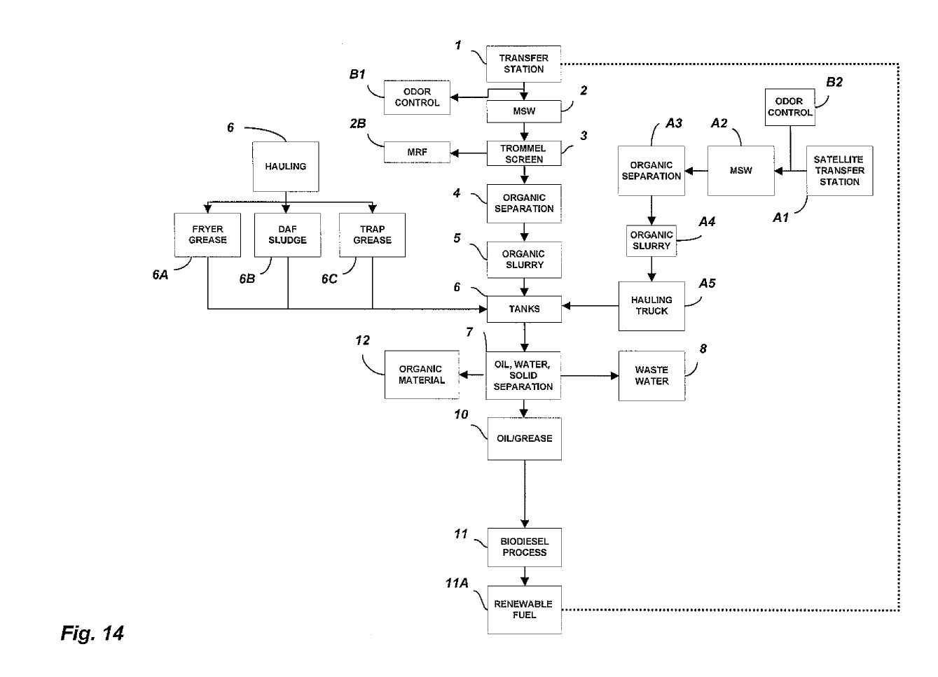

FIG. 14 is a process flow diagram illustrating a method according to another embodiment of the present invention. The process in FIG. 14 is substantially the same as described above with reference to the embodiment of FIG. 13. Additionally, oil 10 produced by separation treatment 7 is subjected to biodiesel process 11 whereby oil 10 (e.g., yellow/brown grease) is refined to produce renewable fuel 11A in the form of a high quality biodiesel fuel, as described above with reference to the embodiment of FIG. 2.

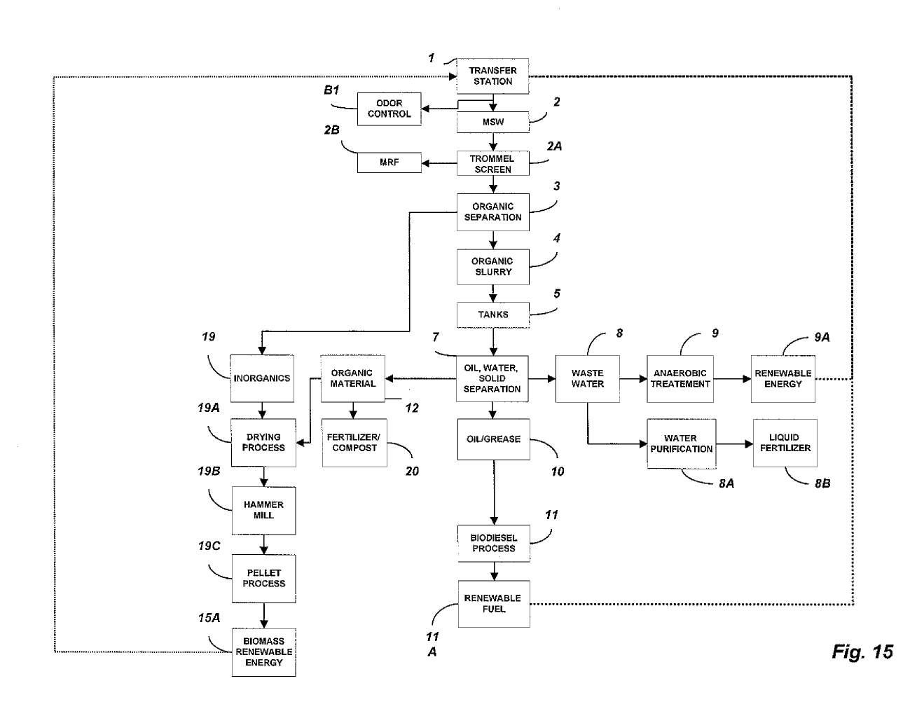

FIG. 15 is a process flow diagram illustrating a method according to another embodiment of the present invention. The process in FIG. 15 is substantially the same as described above with reference to the embodiment of FIG. 11. Additionally, in FIG. 15 waste water 8 produced by separation treatment 7 is subjected to processing to produce liquid fertilizer 8B and renewable energy 9A as described above for the embodiment of FIG. 5.

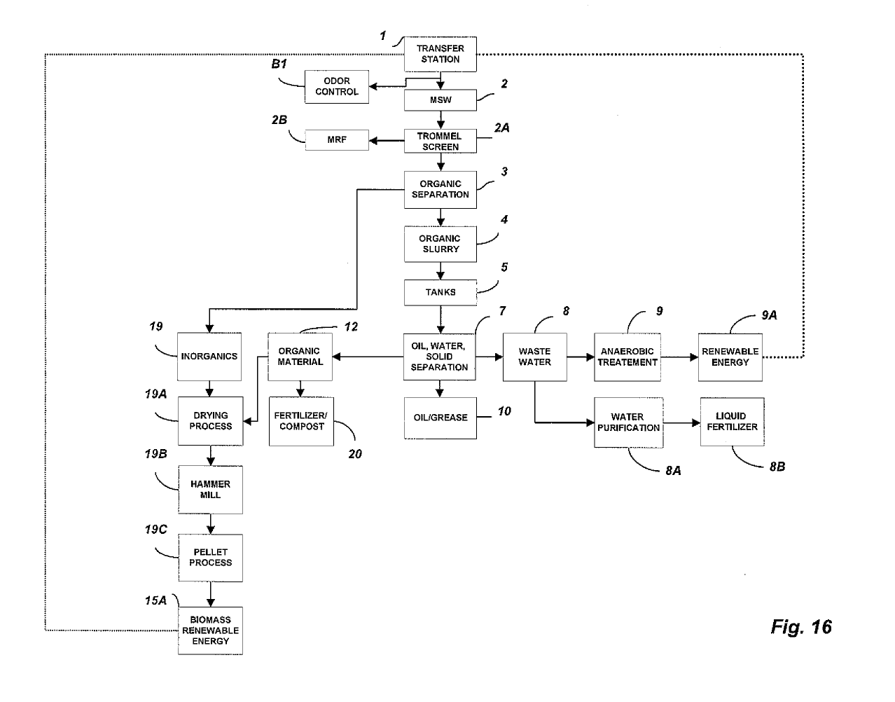

FIG. 16 is a process flow diagram illustrating a method according to another embodiment of the present invention. The process in FIG. 16 is substantially the same as described above with reference to the embodiment of FIG. 6. Additionally, in FIG. 16 waste water 8 produced by separation treatment 7 is subjected to processing to produce liquid fertilizer 8B and renewable energy 9A as described above for the embodiment of FIG. 5.

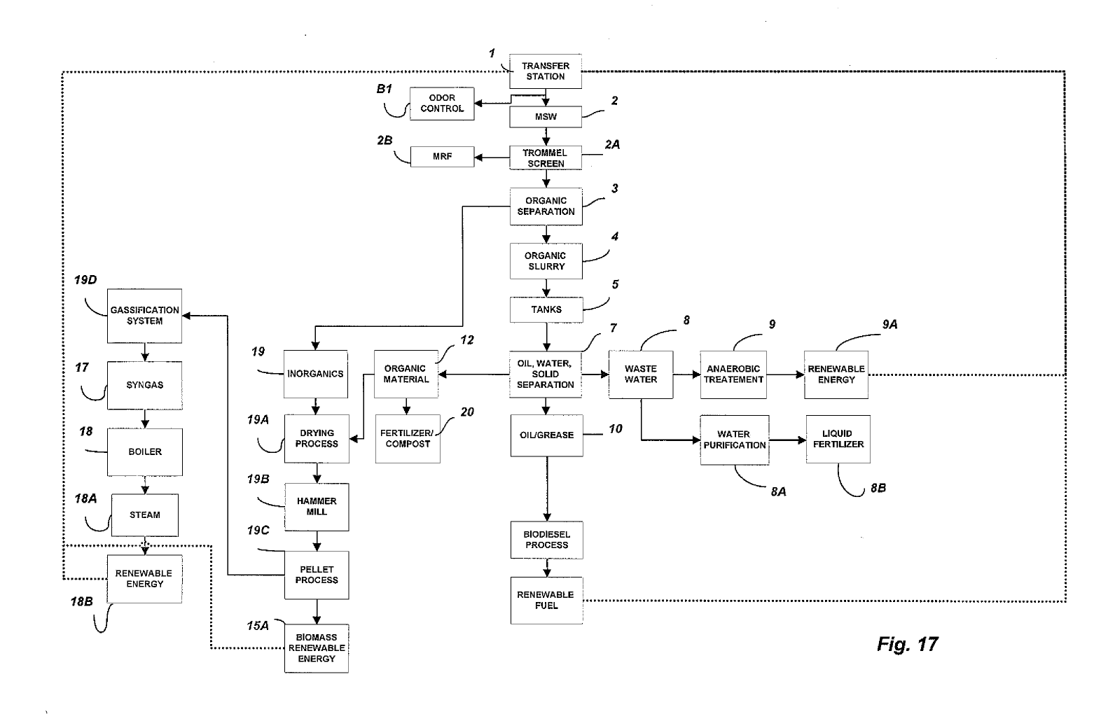

FIG. 17 is a process flow diagram illustrating a method according to another embodiment of the present invention. The process in FIG. 17 is substantially the same as described above with reference to the embodiment of FIG. 15. Additionally, in FIG. 17 organic material 12 and inorganics 19 are further processed to produce additional usable products, including fertilizer/compost 20 and renewable fuels (e.g., pellets 19C; syngas 19D) which can be used to generate renewable energy 15A, 18B, as described above with reference to FIG. 12.

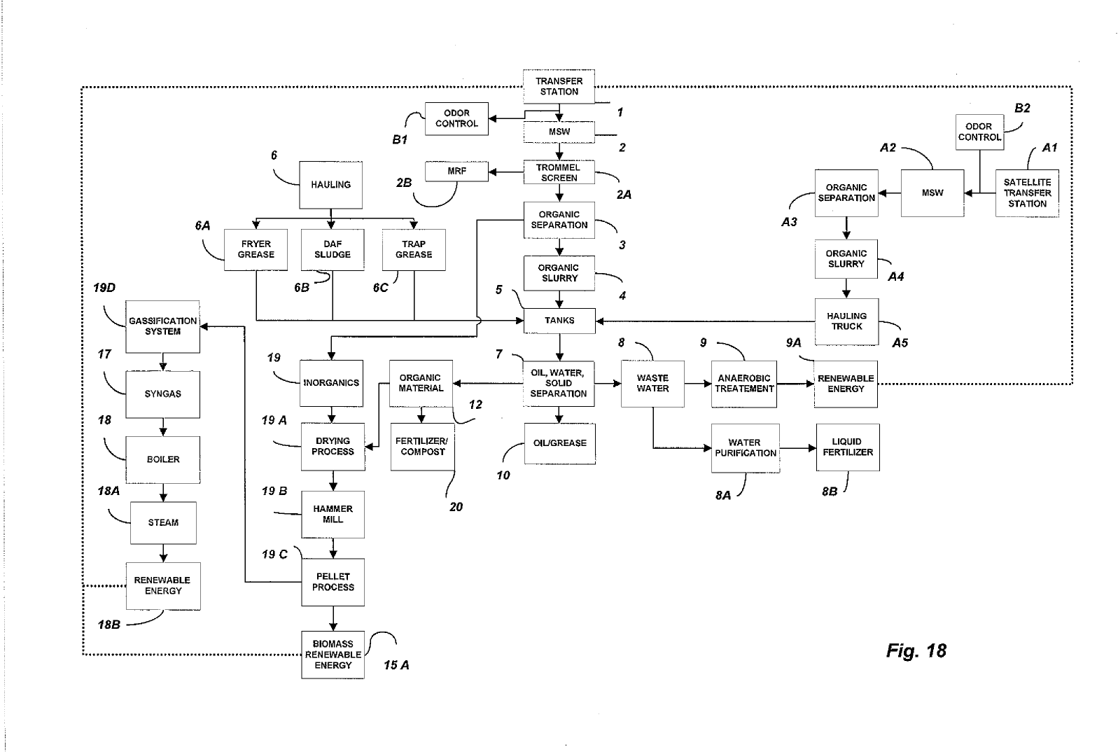

FIG. 18 is a process flow diagram illustrating a method according to another embodiment of the present invention. The process in FIG. 18 is substantially the same as described above with reference to the embodiment of FIG. 13 in which organic material 12 and waste water 8 are produced by subjecting organic slurry 4, organic slurry A4 and raw feedstock waste grease 6A-6C to separation process 7. Additionally, in FIG. 18 the organic material 12 obtained by separation process 7 and inorganics 19 obtained by organic separation process 3 are further processed to produce useful product including fertilizer/compost 20 and renewable fuels (e.g., pellets 19C; syngas 19D) used to generate renewable energy 15A, 18B, as described above with reference to FIG. 7. Furthermore, waste water 8 produced by separation treatment 7 is subjected to processing to produce liquid fertilizer 8B and renewable energy 9A as described above for the embodiment of FIG. 5.

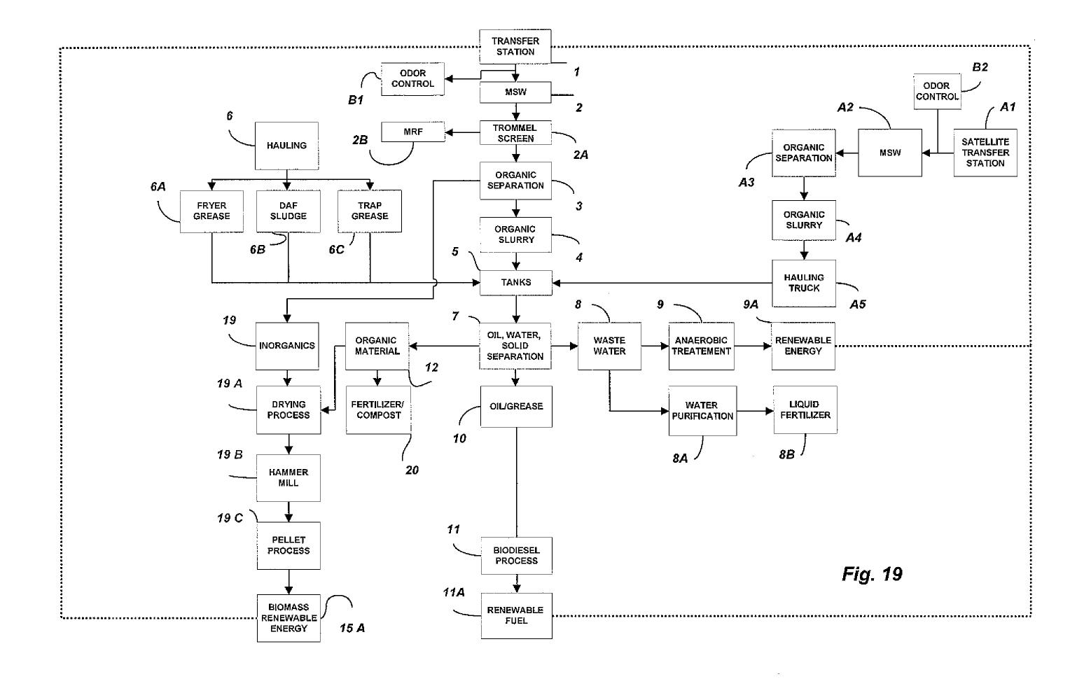

FIG. 19 is a process flow diagram illustrating a method according to another embodiment of the present invention. The process in FIG. 19 is substantially the same as described above with reference to the embodiment of FIG. 13 in which waste water 8, oil 10 and organic material 12 are produced by subjecting organic slurry 4, organic slurry A4 and raw feedstock waste grease 6A-6C that are centrally stored, such as in holding tank 300 as described above, prior to being subjected to separation process 7. Additionally, in FIG. 19 organic material 12 produced by separation process 7 and inorganics 19 produced by organic separation process 3 are further processed to produce additional usable products including fertilizer/compost 20 and renewable fuels (e.g., pellets 19C; syngas 17) which can be processed to generate renewable energy 15A and 18B, as described above with reference to FIG. 6. Furthermore, waste water 8 obtained by separation treatment 7 is subjected to processing to produce liquid fertilizer 8B and renewable energy 9A as described above for the embodiment of FIG. 5. Still further, oil 10 obtained by separation treatment 7 is subjected to a biodiesel process 11 whereby the oil is refined to produce renewable fuel 11A in the form of a high quality biodiesel fuel, as described above with reference to the embodiment of FIG. 2.

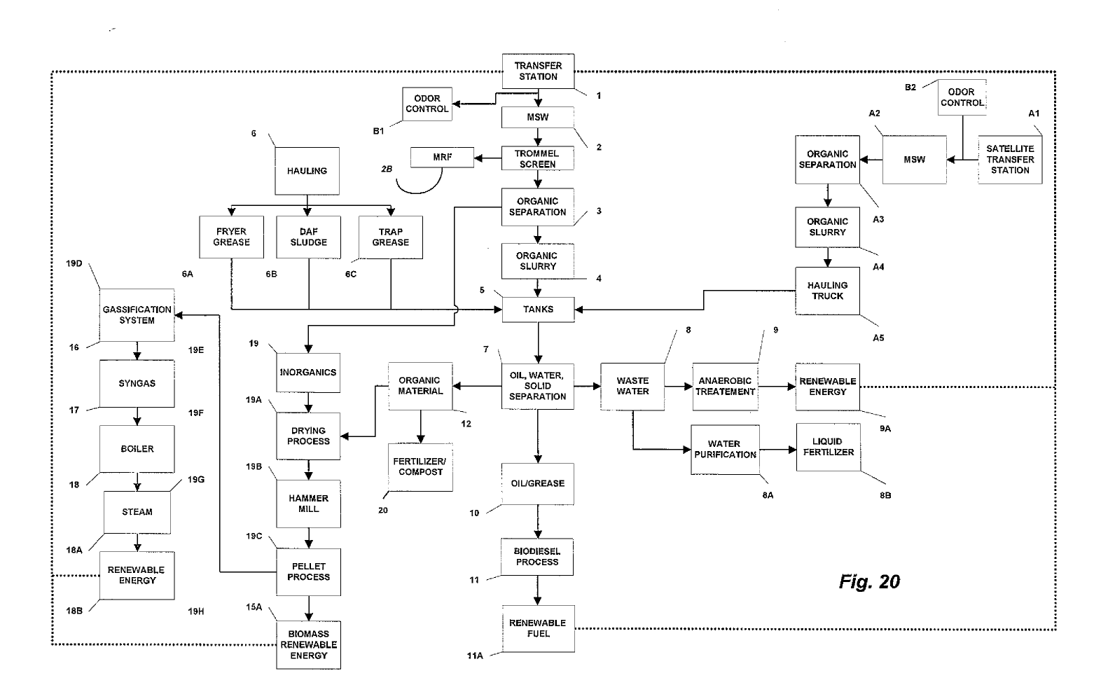

FIG. 20 is a process flow diagram illustrating a method according to another embodiment of the present invention. The process in FIG. 20 is substantially the same as described above with reference to the embodiment of FIG. 19. Additionally, in the process of FIG. 20 organic material 12 and inorganics 19 are further processed to obtain additional usable products as renewable fuels for producing renewable energy, as described above with reference to FIG. 17.

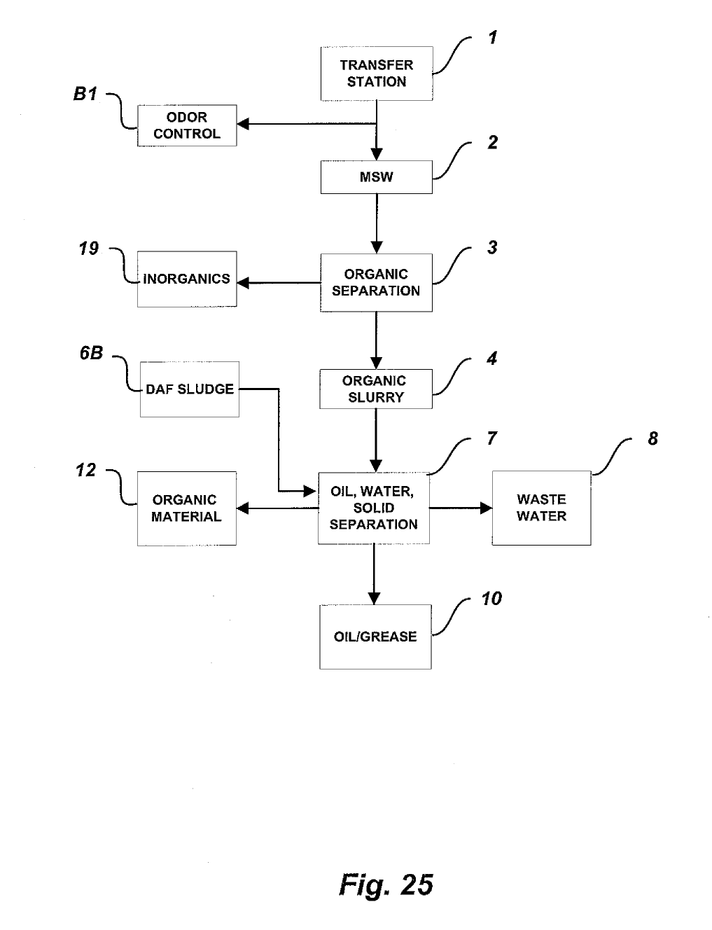

FIG. 25 is a process flow diagram illustrating a method according to another embodiment of the present invention. The process in FIG. 25 is substantially the same as described above with reference to the embodiment of FIG. 1. Additionally, in the process of FIG. 25, DAF sludge 6B is also subjected to separation treatment 7 together with organic sludge 4 to obtain waste water 8, oil/grease 10 and organic material 12 as described above. Industrial food processing residuals other than DAF sludge can also be processed by this method.

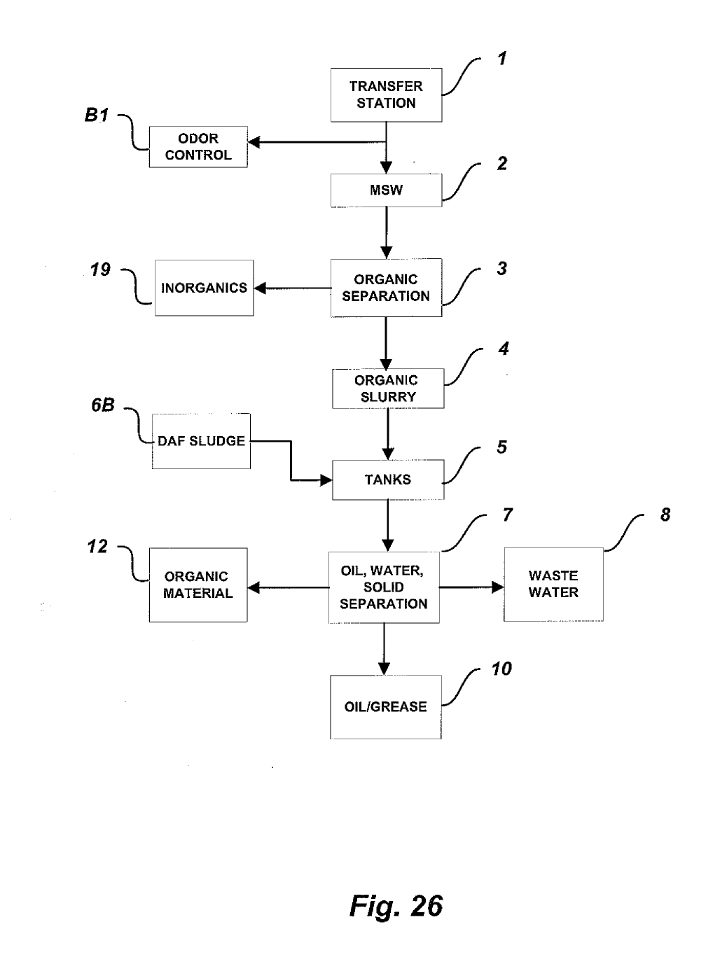

FIG. 26 is a process flow diagram illustrating a method according to another embodiment of the present invention. The process in FIG. 26 is substantially the same as described above with reference to the embodiment of FIG. 1A. Additionally, in the process of FIG. 26, DAF sludge 6B is stored (as shown at 5) together with organic slurry 4 prior to being subjected to separation treatment 7 to obtain waste water 8, oil 10 and organic material 12 as described above. Industrial food processing residuals other than DAF sludge can also be processed by this method.

In yet another method according to the present invention not shown in the drawings, only industrial food processing residuals (e.g., including DAF sludge) is subjected to separation treatment 7 to obtain waste water 8, oil 10 and organic material 12. By this and the foregoing related methods, industrial food processing residuals can be efficiently separated into waste water, oil and organic material components that are available for further processing to obtain useful products as described above. This is in comparison to conventional methods which have focused primarily on concentrating and eliminating industrial food processing residuals as costly residuals of the waste treatment process and not on the potential economic value of these residuals.

As described above, the techniques according to the present invention are suitable for processing various types of waste materials into useful products in a cost effective and environmentally friendly manner. The waste materials include raw feedstock waste grease (e.g., fryer grease; industrial food processing residuals including DAF sludge; trap grease) and/or MSW originating from one or multiple transfer stations, and/or source separated organic waste. It is appreciated by those skilled in the art, however, that the techniques according to the present invention are also suitable for processing other forms of waste materials, such as those originating from vegetable oils and fats, industrial oils and fats, soapstock, industrial tallow, industrial lard, and other forms of animal fats and oils.

The techniques described herein provide for the efficient and cost effective separation of waste water, oil and organic material from organic components of the waste materials, and for the subsequent processing of the separated products to realize various useful products, including nutrient filled organic fertilizers and/or fertilizers/composts, and renewable fuels for producing various types of renewable energy. For example, the separated waste water can be subjected to conventionally known water purification and anaerobic treatments to obtain a liquid fertilizer and a form of renewable energy, respectively. The separated organic material which is in solid or semisolid form is usable as a fertilizer/compost for landscaping, horticulture, and agriculture applications, for example. The separated oil has the composition of yellow grease and/or brown grease ready for further processing to obtain a renewable fuel (e.g., a biodiesel fuel) for producing renewable energy. It is understood by those skilled in the art that other useful products can be obtained by the methods and systems of the present invention, including animal feed additives and raw materials for cosmetics.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for processing waste material, comprising:
separating organic and inorganic waste components from the waste material;
preparing from the separated organic waste component an organic slurry containing waste water, oil/grease and organic material; and
separating the waste water, oil/grease and organic material from the organic slurry.

2. A method according to claim 1; wherein the waste material comprises municipal solid waste material.

3. A method according to claim 1; wherein the waste material comprises a combination of municipal solid waste material and raw feedstock waste grease.

4. A method according to claim 3; wherein the raw feedstock waste grease comprises one or more of fryer grease, trap grease, and food processing residuals including DAF sludge.

5. A method according to claim 1; further comprising storing the organic shiny in a storing unit prior to separating the waste water, oil/grease and organic material.

6. A method according to claim 1; wherein the oil/grease comprises yellow grease and brown grease.

7. A method for processing waste material, comprising:
screening the waste material to separate recyclable components and contaminants from the waste material;
subjecting the screened recyclable components to a first separation treatment by which organic components are separated from inorganic components and formed into an organic slurry containing waste water, oil and organic material;
storing the organic slurry in a storing unit; and
subjecting the stored organic slurry to a second separation treatment outside of the storing unit to separate the waste water, oil/grease and organic material in the organic slurry from one another.

8. A method according to claim 7; further comprising storing in the storing unit raw feedstock waste grease containing waste water, oil/grease and organic material; and wherein the second separation step comprises separating the waste water, oil and organic material in each of the organic slurry and the raw feedstock from one another.

9. A method according to claim 7; wherein the organic slurry comprises a first organic slurry; and further comprising preparing, by the steps of preparing the first organic slurry, a second organic slurry at a location remote from which the first organic slurry is prepared, and storing the second organic slurry in the storing unit along with the first organic slurry; and wherein the second separation step comprises separating the waste water, oil and organic material contained in each of the first and second organic slurries.

10. A method according to claim 7; further comprising the step of converting the separated oil/grease to a renewable fuel.

11. A system for processing waste material, comprising:
a first separating device that separates organic and inorganic waste components from the waste material and forms the organic waste component into an organic slurry containing waste water, oil and organic material; and
a second separating device that separates the organic slurry into the waste water, oil and organic material.

12. A system according to claim 11; wherein the waste material separated by the first separating device comprises municipal solid waste.

13. A system according to claim 11; further comprising a storing unit separate and independent from the first and second separating devices for storing the organic slurry prior to, separation by the second separating device.

14. A system according to claim 13; wherein the waste material separated by the first separation device comprises municipal solid waste; and wherein the storing unit is configured for receiving and storing raw feedstock waste grease that combines with the organic slurry stored in the storing unit.

15. A system according to claim 14; wherein the raw feedstock waste grease comprises one or more of fryer grease, trap grease and food processing residuals including DAF sludge.

16. A system according to claim 15; wherein the municipal solid waste comprises first municipal solid waste and the organic slurry comprises a first organic slurry;
and further comprising another first separation device that separates organic and inorganic waste components from second municipal solid waste different from the first municipal solid waste and that forms a second organic slurry different from the first organic slurry and containing waste water, oil/grease and organic material; and wherein the storing unit is further configured to receive and store the second organic slurry to combine with the first organic slurry and raw feedstock waste grease stored in the holding tank.

17. A system for processing waste material, comprising:
a centralized storing unit that receives (a) an organic slurry prepared from organic components contained in municipal solid waste or source separated organic waste and (b) raw feedstock waste grease; and
a separation device that receives the organic slurry and raw feedstock waste grease stored in the centralized storing unit and that separates waste water, oil/grease and organic material contained in the organic slurry and raw feedstock waste grease from one another.

18. A system according to claim 17; wherein the raw feedstock grease comprises food processing residuals including DAF sludge.

19. A system according to claim 17; wherein the oil/grease comprises yellow and/or brown grease.

20. A system according to claim 17; further comprising an organic separation device for receiving the municipal solid waste or source separated organic waste and preparing the organic slurry.
